(19) United States
(12) Patent Application Publication
(10) Pub. No.: US 2015/0188852 A1
(43) Pub. Date: Jul. 2, 2015

(54) OUT-OF-OFFICE (OOO) AUTOMATION FOR AN E-MAIL APPLICATION

(71) Applicant: Bank of America Corporation, Charlotte, NC (US)

(72) Inventors: Vipul Seth, Hyderabad (IN); Anand Daga, Hyderabad (IN); Gurdeep Walia, Hyderabad (IN); Narasimhan Raghavendran, Secunderabad (IN); Saroj K. Bonthapalli, Secunderabad (IN)

(73) Assignee: Bank of America Corporation, Charlotte, NC (US)

(21) Appl. No.: 14/146,342

(22) Filed: Jan. 2, 2014

(51) Int. Cl. H04L 12/58

(52) U.S. Cl. CPC H04L 51/02

(57) ABSTRACT

A computer system enables a business to support the automation of out-of-office (OOO) messaging when a recipient of e-mail is unavailable. An out-of-office message configurator operates in co-operation with the e-mail application for out-of-service messaging so that configuration information is automatically requested to specify the content of an OOO message before a first person logs off the computer system. The configured OOO message may then be analyzed to verify that the message complies with a set of rules such as an e-mail policy in a business environment. Consequently, when an e-mail message is received from a second person and the first person is unavailable, an OOO message may be returned to the second person. Different variations of an OOO message may also be selected based on the specifics of the second person.

### FIELD

Aspects described herein relate to a computer system that supports the automation of out-of-office (OOO) messages when a user is unavailable to respond to an electronic mail (e-mail) message.

### BACKGROUND

Electronic mail, commonly referred as e-mail, is a technique used for exchanging digital messages from one person (the sender) to one or more recipients. When used in a business environment, the sender, who is often a customer of the business, typically expects a response from the recipient in a reasonable amount of time. However, the recipient may be unavailable for some reason so that a response to the e-mail is delayed until the recipient returns to work. For example, the recipient may be on vacation, sick, traveling on business, and so forth. If the sender is unaware of the situation, the sender may perceive a lack of professionalism and thus develops a negative opinion of the business. In some situations, a business request, as expressed in the e-mail, may require a timely resolution, and thus the sender needs to be aware of whom to contact when the recipient is unavailable. Consequently, it is often important that others are informed about another's availability status in a consistent and reliable fashion.

### BRIEF SUMMARY

Aspects described herein address one or more of the issues mentioned above by disclosing methods, computer readable media, and apparatuses that support the automation of out-of-office messaging when a recipient of electronic mail (e-mail) is not available. With an e-mail application, which may be used for sending and receiving business information and exchanging communications between the business units, the received information may represent vital source documentation for processing the requests per the instructions from clients. For example, an account analysts may decide whether to proceed or discard a request from a client (typically who is a customer) depending on the type of received information. Also, the process may be predicated on completing the request within the stipulated time. If the analyst is not available at the office and did not activate his/her out-of-office (OOO) message, there are chances that the request will not result in any action because the details from the submitter was not received within a specified time duration or will exceed a stipulated time. An out-of-office message configurator works in concert with an e-mail application to support the automation of out-of-office messages in order to enhance a customer experience, thus reducing the time for completing the request process and providing escalation contact information when the recipient (e.g., an account analyst) is not available.

At least some aspects of the disclosure relate to methods, computer-readable media, and apparatuses opening an e-mail application that provides communication services for a first person, in which an out-of-office message configurator operates in co-operation with the e-mail application for out-of-service messaging. When the e-mail application is closed and the out-of-office message configurator is enabled, configuration information is automatically requested to specify content of an out-of-office message that is indicative of an out-of-office status for the first person. When an e-mail message addressed to the first person from a second person is received, the first out-of-office message is returned to the second person. The out-of-office message configurator may be implemented in a number of ways. For example, the out-of-office message configurator comprises a macro that includes a series of computer-executable instructions that are grouped together as a single command to accomplish a task in an automatic fashion.

With another aspect of the embodiments, activation of OOO messaging may be ensured by requiring that a user configure OOO messaging after closing the e-mail application and before logging off a computing device.

With another aspect of the embodiments, an out-of-office message configurator may interact with an e-mail application to configure an OOO message. The configured OOO message may be analyzed to verify that the message complies with a set of rules such as an e-mail policy in a business environment.

With another aspect of the embodiments, when the out-of-office message configurator is not installed on an apparatus and when the software application is opened, the out-of-office message configurator is downloaded on the apparatus and then enabled.

With another aspect of the embodiments, the content of an OOO message is analyzed according to a set of rules, and an indication is generated whether the content should be modified. The set of rules may comprise grammatical rules, spelling rules, and/or semantic rules.

With another aspect of the embodiments, an out-of-office message configurator may support different variations of an OOO message. A message variation is selected based on a particular sender of an e-mail message. For example, different clients may have different escalation contacts. As another example, different degrees of information may be included for intra-business e-mail versus e-mail received from outside the business.

Aspects of the embodiments may be provided in a computer-readable medium having computer-executable instructions to perform one or more of the process steps described herein.

These and other aspects of the embodiments are discussed in greater detail throughout this disclosure, including the accompanying drawings.

### BRIEF DESCRIPTION OF THE DRAWINGS

The present invention is illustrated by way of example and not limited in the accompanying figures in which like reference numerals indicate similar elements and in which:

FIG. 1 shows a system that supports e-mail delivery in accordance with an aspect of the embodiments.

FIG. 2 shows an illustrative operating environment in which various aspects of the embodiments may be implemented.

FIG. 3 shows basic stages for automating out-of-office (OOO) messaging in accordance with an aspect of the embodiments.

FIG. 4 shows a flow chart for automating out-of-office (OOO) messaging in accordance with an aspect of the embodiments.

FIG. 5 shows a flow chart for installing a macro for supporting out-of-office (OOO) automation in accordance with an aspect of the embodiments.

FIG. 6 shows a flow chart for configuring out-of-office (OOO) messages in accordance with an aspect of the embodiments.

FIG. 7 shows an exemplary out-of-office (OOO) message that is generated in accordance with an aspect of the embodiments.

FIG. 8 shows an exemplary out-of-office (OOO) message that is generated in accordance with an aspect of the embodiments.

FIG. 9 shows a flow chart for processing out-of-office messaging in accordance with an aspect of the embodiments.

FIG. 10 shows a flow chart for configuring out-of-office (OOO) messages based on a message template in accordance with an aspect of the embodiments.

### DETAILED DESCRIPTION

In accordance with various aspects of the embodiments, methods, computer-readable media, and apparatuses are disclosed for automating out-of-office (OOO) messages in conjunction with an e-mail application when a user is unavailable. For example, the user may be on vacation or sick.

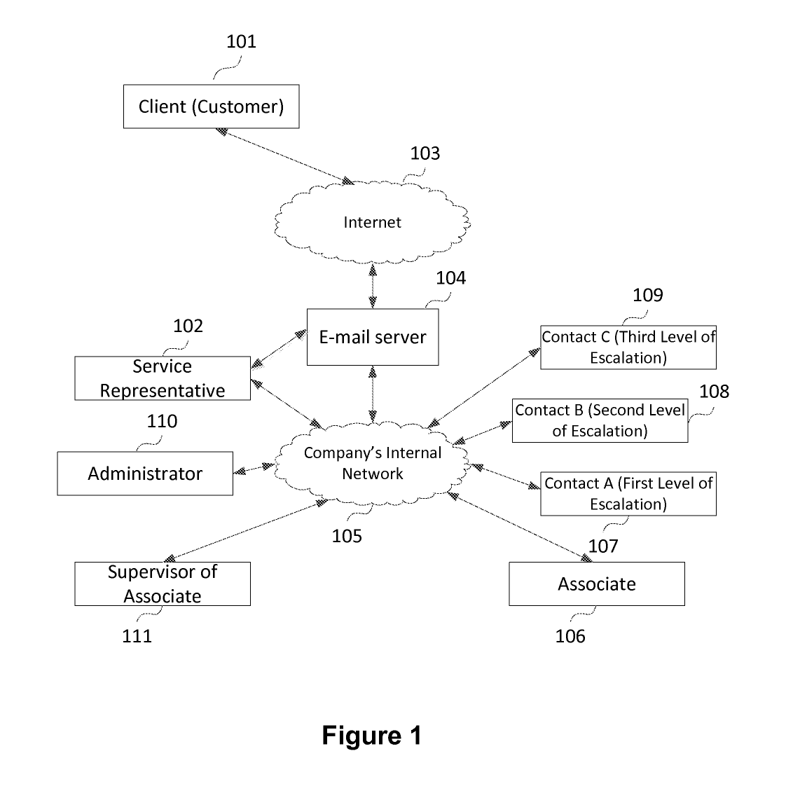

An e-mail application may be an application that is used for sending and receiving business information and/or exchanging electronic communications (often referred as e-mail) between members of business units in a company or between a person external to the company (e.g., a customer) and an employee. The e-mail application may execute on a user's computing device or on a combination of the user's computing device and e-mail server (e.g., server 104 as shown in FIG. 1).

When a recipient of e-mail is unavailable, an out-of-office message may be sent to the sender, informing the sender of the recipient's unavailability. However, if OOO messaging has not been activated, an OOO message may not be generated, and consequently the sender would not be cognizant of the unavailability. Providing an OOO message is typically considered courteous and allows the sender to manage expectations and avoid frustration. Moreover, in a business environment, the sender (who may be a customer or may be an employee providing service to a customer) may be unable to have a request completed in a timely basis if the recipient is unavailable without the sender knowing about proper backup support.

Activation of OOO messaging may be ensured by requiring that a user configure OOO messaging after closing the e-mail application and before logging off a computing device.

As will be discussed, an out-of-office message configurator may interact with an e-mail application to configure an OOO message. The configured OOO message may be analyzed to verify/validate that the message complies with a set of rules such as an e-mail policy in a business environment.

FIG. 1 shows a system that supports e-mail delivery in accordance with an aspect of the embodiments. For example, a customer (client) 101 may contact service representative 102 of a business, for example via e-mail or telephone, to request some service for the customer's account. If customer 101 is communicating via e-mail, the request may be transported through Internet 103 and e-mail server 104. Although not explicitly shown, each entity 101-102 or 106-111 may utilize a computing device to execute an e-mail application to send and/or receive e-mail communications from another computing entity.

In order to effectively provide the requested service, service representative 102 may need information about the client's account from associate 106 (which may be referred as an account analyst), and consequently may send e-mail to associate 106 via e-mail server 104 and internal network 105. The requested information may act as a vital source of documentation for processing the requests per the instructions from client 101. For example, a request may pertain to an account dealing with billing and maintenance of statements. The process may handle different kinds of maintenance, refunds, complex adjustments, and pricing of services. The process may also require analysis of the account, in which service representative 102 sends an e-mail message to associate (analyst) 106 for assistance in resolving the request. Account analyst 106 may decide whether to proceed or to reject the request and to convey the decision to service representative 102. With some embodiments, the company may be obligated to complete the request within the stipulated time as per a service level agreement (SLA).

However, in accordance with traditional approaches, the e-mail message may not be answered in a timely manner if associate 106 is unavailable and OOO messaging is not activated. If associate 106 did not activate his/her out-of-office message when unavailable, service representative 102 may not be able to complete the request within the stipulated time. As will be discussed, an aspect of the embodiments ensures that an out-of-office message is generated when associate 106 exits the e-mail application before logging off the company's computer system.

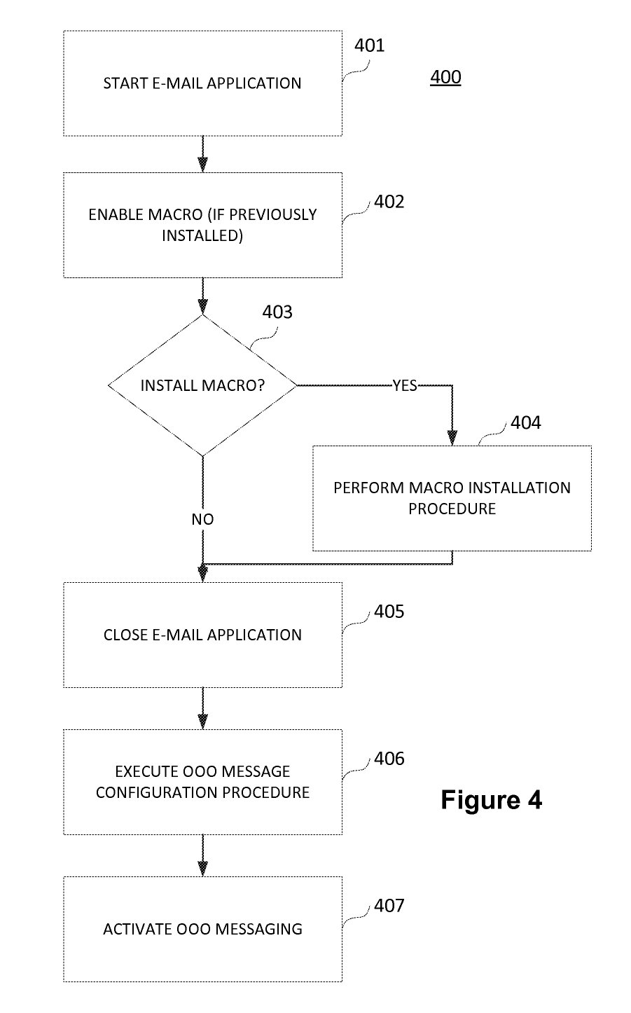

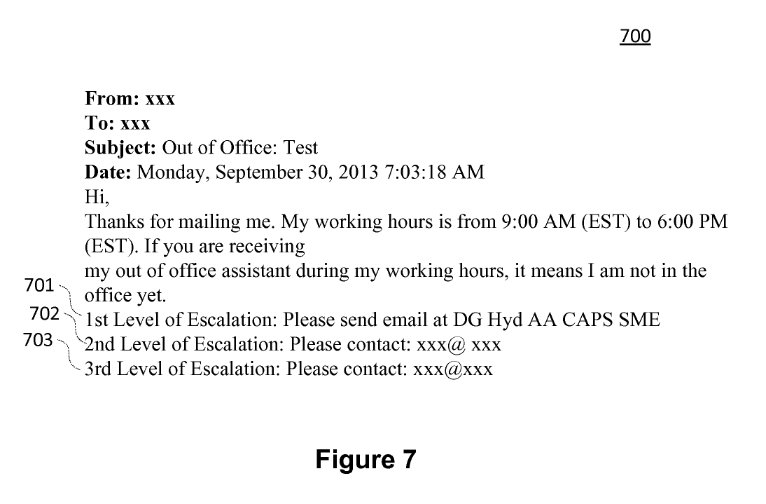

The automation out-of-office (OOO) message configurator (which may be represented in flow chart 400 in FIG. 4 as will be discussed) executes in cooperation with an e-mail application, enhancing the client (customer) experience by ensuring and/or reducing request response times. For example, if associate 106 is unavailable, an out-of-office message may be generated to inform service representative 102 to contact escalation contacts 107, 108, or 109 in an escalating order (corresponding to entries 701, 702, and 703, respectively as shown in FIG. 7). The automation OOO message configurator contains computer executable instructions that, when enabled, ensures that an OOO message is generated when the user closes (exits) the e-mail application. The generated OOO message typically informs service representative 102 about the unavailability of associate 106 as well as informing service representative 102 about alternative contacts so that service representative 102 can resolve a request from client 101 in a timely manner.

With some embodiments, the automation out-of-office message configurator may be implemented as a macro, which may be accessed by the e-mail application. A macro is a term for a series of commands and instructions that are grouped together as a single command to accomplish a task automatically. The macro may be implemented as code script that causes a window to be displayed on a computer device of associate 106 when closing the e-mail application. The window generates a displayed question asking associate 106 either to choose existing or to amend the OOO message. As per the selection, OOO messaging will be automatically activated. In addition, the macro supports a control check to ensure that the associate mandatorily keeps the OOO message activated before logging off the business computer system.

According to an aspect of the embodiments, when associate 106 closes the e-mail application, the out-of-office configurator automatically requests configuration without associate explicitly initiating the configuration of OOO messaging by associate 106. This approach ensures that OOO messaging is properly activated when associate 106 is not available at a subsequent time after closing the e-mail application.

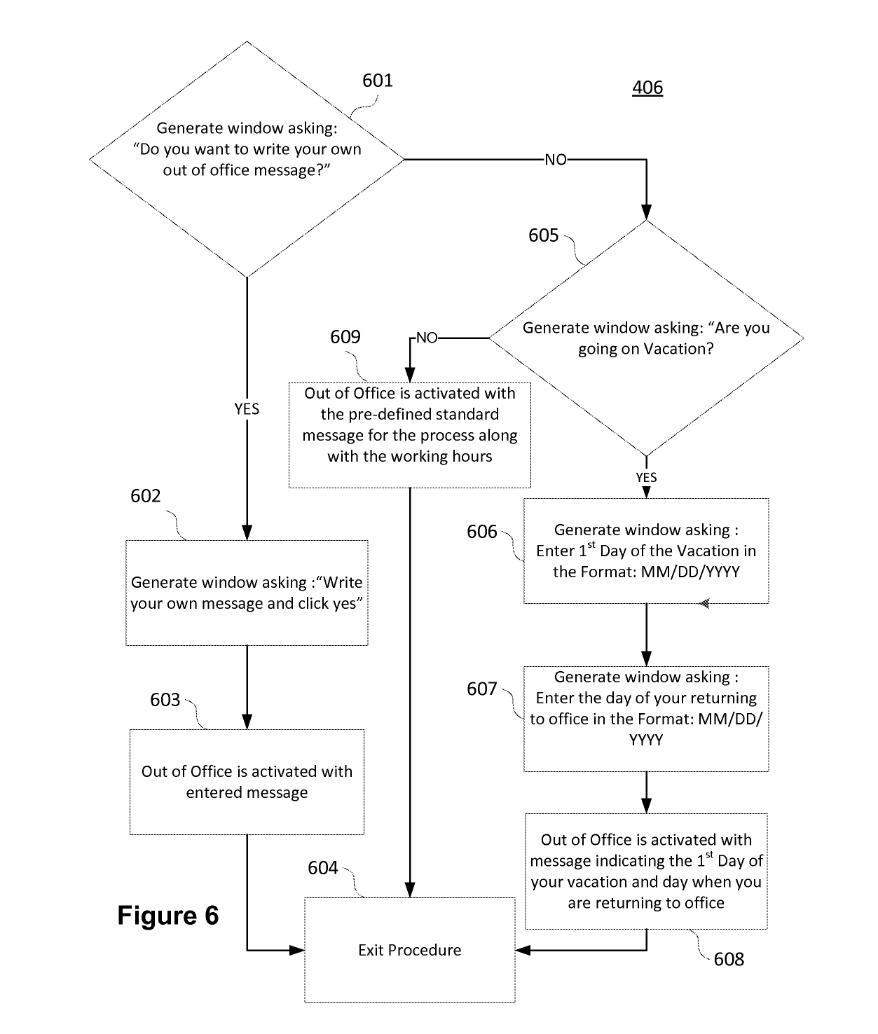

The out-of-office message configurator may collect configuration in response to the configuration request so that the content of an OOO message includes updated information about the status of associate 106. For example, configuration information may include the reason for the associate's absence (e.g., vacation), when the associate is unavailable, and whom to contact during the absence. An exemplary embodiment is shown in FIG. 6 as will be discussed.

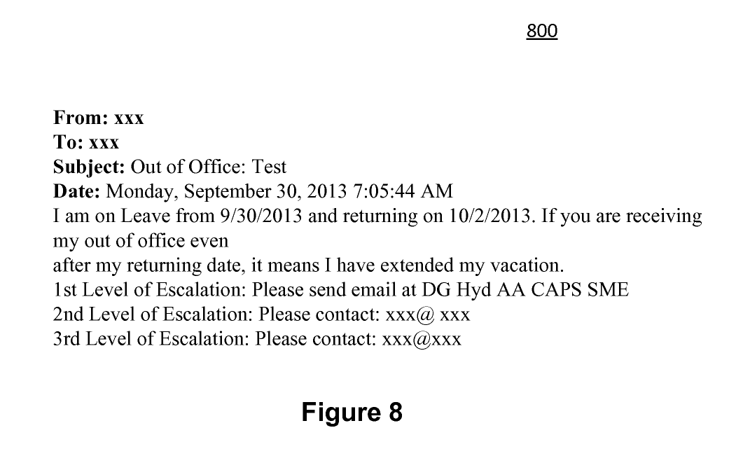

As will be discussed, the content of OOO messages may be verified after associate 106 has configured OOO messaging. For example, test OOO messages as shown in FIGS. 7 and 8 may be sent to supervisor 111 (of associate 106). The validity of the message content can then be verified. For example, the escalation contacts may be verified to ensure that the escalation contacts are available when associate 106 is unavailable.

With some embodiments, an OOO message may be sent only once to a particular sender when the recipient is unavailable. However, some embodiments, may respond with an OOO message periodically (some or all of the time) when e-mail is received from a particular sender.

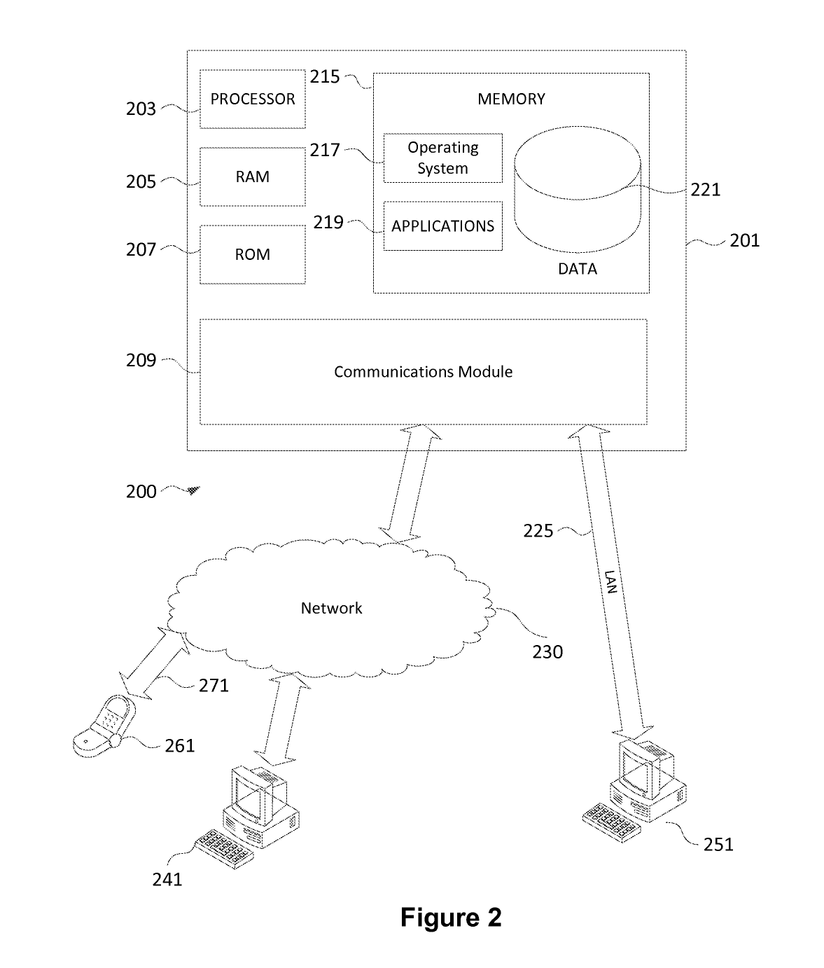

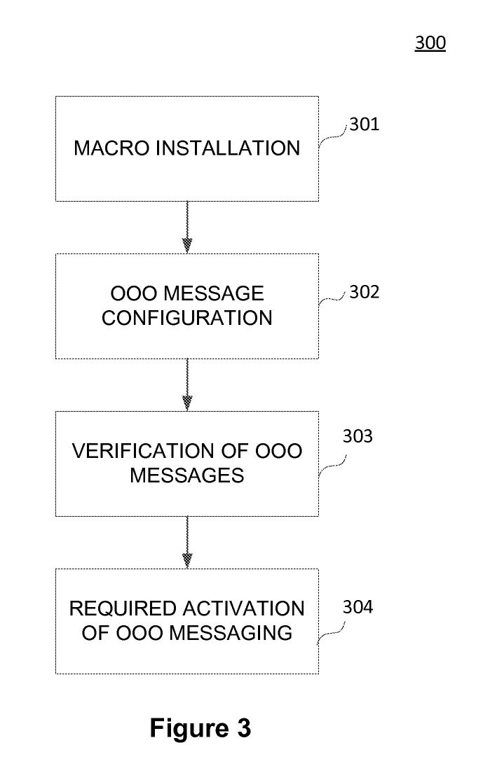

FIG. 2 illustrates an example of a suitable computing system environment 100 that may be used according to one or more illustrative embodiments for implementing any of the computing devices in FIG. 1, performing processes 300, 400, 404, 406, 900, and 901 as shown in FIGS. 3-6 and 9-10, respectively, and/or generating exemplary OOO messages as shown in FIGS. 7-8. The computing system environment 200 is only one example of a suitable computing environment and is not intended to suggest any limitation as to the scope of use or functionality of the invention. The computing system environment 200 should not be interpreted as having any dependency or requirement relating to any one or combination of components shown in the illustrative computing system environment 200.

The invention is operational with numerous other general purpose or special purpose computing system environments or configurations. Examples of well-known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

With reference to FIG. 2, the computing system environment 200 may include a computing device 201 wherein the processes discussed herein may be implemented. The computing device 201 may have a processor 203 for controlling overall operation of the computing device 201 and its associated components, including RAM 205, ROM 207, communications module 209, and memory 215. Computing device 201 typically includes a variety of computer readable media. Computer readable media may be any available media that may be accessed by computing device 201 and include both volatile and nonvolatile media, removable and non-removable media. By way of example, and not limitation, computer readable media may comprise a combination of computer storage media and communication media.

Computer storage media include volatile and nonvolatile, removable and non-removable media implemented in any method or technology for storage of information such as computer readable instructions, data structures, program modules or other data. Computer storage media include, but is not limited to, random access memory (RAM), read only memory (ROM), electronically erasable programmable read only memory (EEPROM), flash memory or other memory technology, CD-ROM, digital versatile disks (DVD) or other optical disk storage, magnetic cassettes, magnetic tape, magnetic disk storage or other magnetic storage devices, or any other medium that can be used to store the desired information and that can be accessed by computing device 201.

Communication media typically embodies computer readable instructions, data structures, program modules or other data in a modulated data signal such as a carrier wave or other transport mechanism and includes any information delivery media. Modulated data signal is a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media.

Computing system environment 200 may also include optical scanners (not shown). Exemplary usages include scanning and converting paper documents, e.g., correspondence and receipts to digital files.

Although not shown, RAM 205 may include one or more are applications representing the application data stored in RAM memory 205 while the computing device is on and corresponding software applications (e.g., software tasks), are running on the computing device 201.

Communications module 209 may include a microphone, keypad, touch screen, and/or stylus through which a user of computing device 201 may provide input, and may also include one or more of a speaker for providing audio output and a video display device for providing textual, audiovisual and/or graphical output.

Computer-executable instructions may be stored within memory 215 and/or storage to provide instructions to processor 203 for enabling computing device 201 to perform various functions. For example, memory 215 may store computer-executable used by the computing device 201, such as an operating system 217, application programs 219, and an associated database 221. Alternatively, some or all of the computer executable instructions for computing device 201 may be embodied in hardware or firmware (not shown). Database 221, for example, may provide centralized storage of a mapping between alias URLs and actual URLs, that may be received from different points in system 200, e.g., computers 241 and 251 or from communication devices, e.g., communication device 261. Also, database 221 may contain parameters for determining a risk score of a webpage as will be further discussed.

Computing device 201 may operate in a networked environment supporting connections to one or more remote computing devices, such as computing device 251. Computing device 251 may be a personal computing device or server that may include many or all of the elements described above relative to the computing device 201.

Information such as URL mappings and/or risk score parameters may be accessed through network 230 using computing device such as personal computing device 241 or mobile device 261. Mobile device 261 may be a mobile device communicating over wireless carrier channel 271 through network 230.

The network connections depicted in FIG. 2 include a local area network (LAN) 225 and network 230, but may also include other networks. When used in a LAN networking environment, computing device 201 is connected to the LAN 225 through a network interface or adapter in the communications module 209. When used in a wide area network (WAN) networking environment, the server 201 may include a modem in the communications module 209 or other means for establishing communications, such as the network 230. It will be appreciated that the network connections shown are illustrative and other means of establishing a communications link between the computing devices may be used. The existence of any of various well-known protocols such as TCP/IP, Ethernet, FTP, HTTP and the like is presumed, and the system can be operated in a client-server configuration to permit a user to retrieve web pages from a web-based server. Any of various conventional web browsers can be used to display and manipulate data on web pages. The network connections may also provide connectivity to a CCTV or image/iris capturing device.

Additionally, one or more application programs 219 used by the computing device 201, according to an illustrative embodiment, may include computer executable instructions for invoking user functionality related to communication including, for example, email, short message service (SMS), and voice input and speech recognition applications.

Embodiments of the invention may include forms of computer-readable media. Computer-readable media include any available media that can be accessed by a computing device 201. Computer-readable media may comprise storage media and communication media. Storage media include volatile and nonvolatile, removable and non-removable media implemented in any method or technology for storage of information such as computer-readable instructions, object code, data structures, program modules, or other data. Communication media include any information delivery media and typically embody data in a modulated data signal such as a carrier wave or other transport mechanism.

Although not required, various aspects described herein may be embodied as a method, a data processing system, or as a computer-readable medium storing computer-executable instructions. For example, a computer-readable medium storing instructions to cause a processor to perform steps of a method in accordance with aspects of the invention is contemplated. For example, aspects of the method steps disclosed herein may be executed on a processor on a computing device 201. Such a processor may execute computer-executable instructions stored on a computer-readable medium.

The steps that follow, in reference to FIGS. 3-9, may be implemented by one or more of the components in FIG. 2 and/or other components, including other computing devices.

FIG. 3 shows basic stages for automating out-of-office (OOO) messaging in accordance with an aspect of the embodiments. At stage 301, a macro for supporting OOO messaging is installed at a user's computing device (for example for associate 106). The macro may be installed while the e-mail application is open, where displayed windows are generated to facilitate the installation. With some of the embodiments, the macro may be installed by cutting and pasting a representation of computer code into a window from a source file. However, other embodiments may utilize pushing or pulling the macro from a computing device of administrator 110 to the computing device of associate 106.

At stage 302, the installed macro ensures that associate 106 configures OOO messages when the e-mail application is closed before logging off the computer system. For example, process 406, as shown in FIG. 6, may be performed by a computing device to configure OOO messages when associate 106 is on vacation, unavailable after business hours, and so forth.

At stage 303, test messages may be generated to verify the accuracy of the contact information. With some embodiments, one or more test OOO messages may be sent to supervisor 111 for verification. For example, escalation contact information may be checked to verify that the designated people will be available during the designated time duration. With some embodiments, a test OOO message may be generated in response to an e-mail sent to associate 106 from supervisor 111 to verify the accuracy of the OOO message before associate 106 logs off the business computer system. Alternatively, a test OOO message may be automatically generated when OOO message configuration procedure 406 is closed.

At stage 304, OOO messaging is activated so that if service representative 102 sends e-mail to associate 106 when unavailable, an appropriate e-mail response is returned to service representative 102.

FIG. 4 shows flow chart 400 for a macro in order to automate out-of-office (OOO) messaging in accordance with an aspect of the embodiments. At block 401, associate 106 starts (opens) an e-mail application, typically at the beginning of a work day.

If the macro has been previously installed, the macro is enabled at block 402. The enabling may be initiated in different ways. For example, a window may be displayed so that associate 106 can explicitly select the enabling of the macro. However, with some embodiments, the macro may be automatically enabled when associate 106 opens the e-mail application. When the macro is enabled, OOO messages are not typically generated while the e-mail application is open.

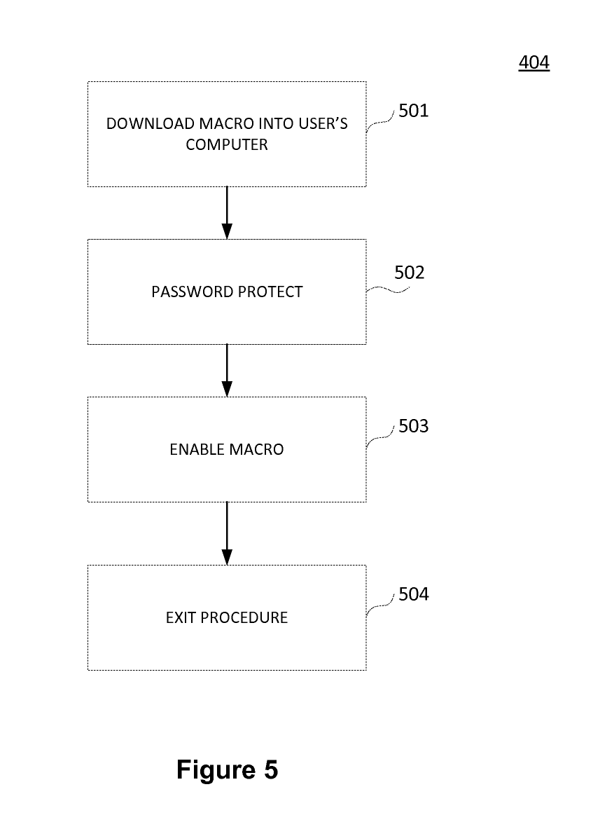

If the macro is to be installed, as determined at block 403, procedure 404 is performed as discussed in FIG. 5.

When associate 106 closes the e-mail application at block 405, OOO message configuration procedure 406 is automatically executed to ensure that OOO messaging is enabled when associate 106 is unavailable. Associate 106 configures an appropriate OOO message based on his/her planned circumstances as will be discussed in FIG. 6. Because of the automatic activation of procedure 406, OOO messaging is ensured when associate 106 is unavailable at block 407.

FIG. 5 shows flow chart 404 for installing the macro for supporting OOO automation in accordance with an aspect of the embodiments. At block 501, the macro is downloaded into the computing device of associate 106. While the macro may be executed with the e-mail application on the associate's computing device, with some embodiments, some portions of the e-mail application and/or macro may execute on another computing device, e.g., e-mail server 104.

Once the macro has been downloaded, the macro may be password protected at block 502 by associate 106 for security purposes, e.g., so that the macro cannot be modified by someone that is unauthorized.

At block 503, the macro is enabled, either explicitly via a window by associate 106 or automatically when blocks 501 and 502 have been completed. Procedure 404 is then exited at block 504 so that OOO messaging is activated at block 407 as discussed in FIG. 4.

FIG. 6 shows flow chart 406 for configuring out-of-office (OOO) messages in accordance with an aspect of the embodiments. Associate 106 configures an appropriate OOO message type based on the planned circumstances. For example, associate 106 may compose a message in free format at blocks 601-603 so that the OOO message is tailored to the associate's planned situation. Alternatively, associate 106 may configure an OOO message for a planned vacation at blocks 605-608 based on entered days of the vacation. A default OOO message type may be initiated if the other OOO types have not been invoked. For example, a pre-defined standard OOO message is invoked at block 609. Once the OOO message is configured, procedure 406 exits at block 604.

Information about escalation contacts (e.g., corresponding to contacts 107-109 as shown in FIG. 1 and contacts 701-703 as shown in FIG. 7) may also be incorporated in the OOO messages. With some embodiments, the contact information may be embedded within the macro in a fixed fashion. However, with some embodiments, the contact information may be variable, where the information is entered during the macro installation or by entering information when configuring the OOO message.

FIG. 7 shows an exemplary out-of-office (OOO) message that is generated in accordance with an aspect of the embodiments. Message 700 may be generated if block 609 has been performed in FIG. 6 and associate 106 is unavailable (e.g., normal work hours).

FIG. 8 shows an exemplary out-of-office (OOO) message that is generated in accordance with an aspect of the embodiments. Message 800 may be generated if blocks 606-608 have been performed in FIG. 6 and associate 106 is unavailable (e.g., on vacation).

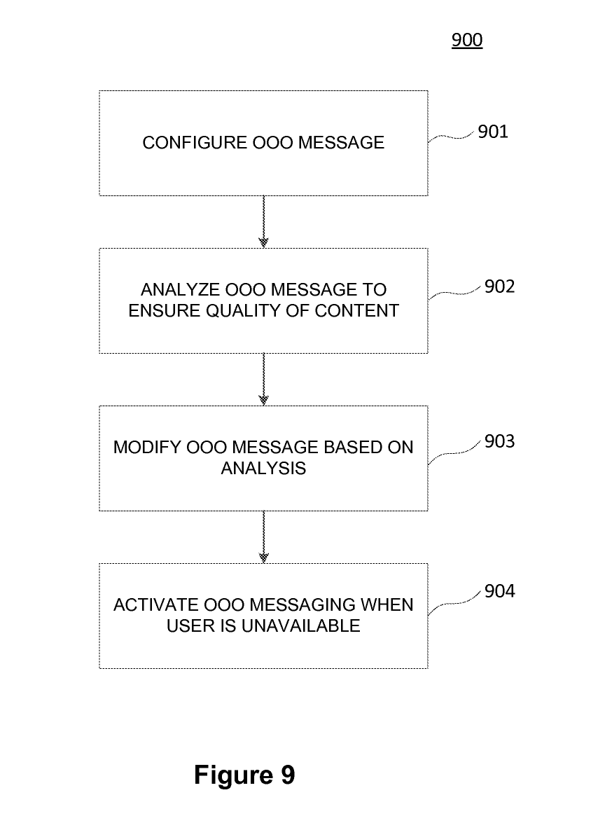

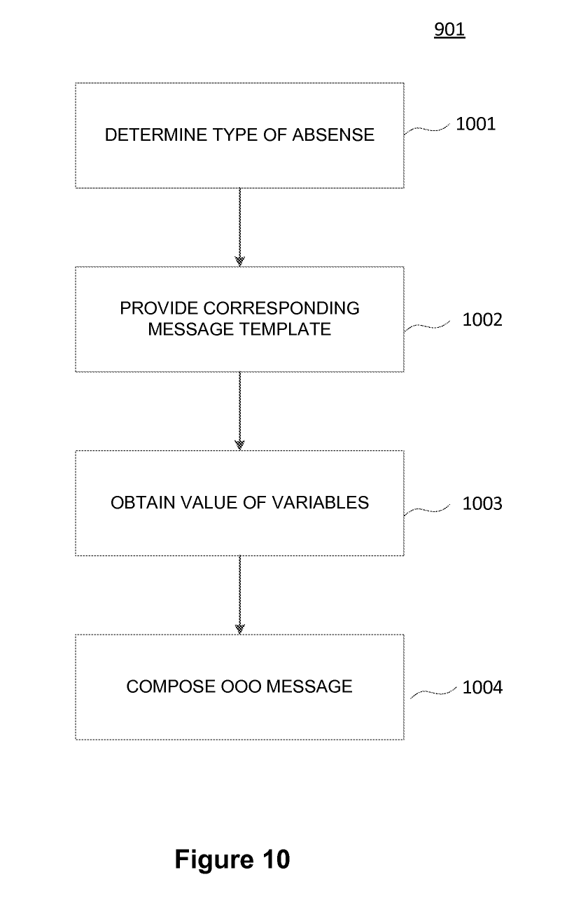

FIG. 9 shows flow chart 900 for processing out-of-office messaging in accordance with an aspect of the embodiments. At block 901, one or more OOO messages are configured for a user when the user plans to be unavailable. For example, OOO messages may be configured as discussed with FIG. 6 or may be configured in accordance with one or more message templates as will be discussed in FIG. 10.

At block 902, the configured OOO message may be analyzed to verify the spelling and grammar of the OOO message as well as the semantic characteristics, particularly when the user enters his/her own message rather than a predefined OOO message. Depending on the responsibilities of the user, a configured OOO message may be analyzed with respect to some or all of the following informational components. For example, OOO analysis may ensure that the dates are properly expressed (e.g., “I'll return August 22 instead of Aug. 22, 2011”). OOO analysis may also ensure that information is precise (e.g., avoid saying “I'll be gone for two weeks or returning next Monday.” Rather, it may be preferred to state “I'll return on August 22.”)

OOO analysis may also assess the OOO message with respect to business e-mail policies. For example, OOO analysis may detect inappropriate language and symbols such as smiley faces, cheesy lines, terms of endearment (“honey” or dear”) and sexist language. Also, OOO analysis may ensure that the reason for the analysis is properly presented.

OOO analysis may also ensure that an OOO message presents contact information for the responsible person who can handle one's work in an emergency or during the duration of the unavailability. This information provides someone with an urgent request or problem with some options. If one works in a large corporation and interacts with a large team handling different areas, one may include a list of names, e-mail addresses and phone numbers corresponding to the different products/services that each list team member handles.

In addition, OOO analysis may ensure that abbreviations or jargon are not contained in the OOO message. Rather, OOO analysis may ensure that terms are spelled out so that someone outside the organization can better understand a referenced term.

At block 903, OOO processing may modify the OOO message to be in accordance with OOO analysis. With some embodiments, modifications may be performed without intervention of the user; however, with some embodiments an out-of-office message configurator may inform the user of the suggested changes and incorporate them into the modified OOO message if selected and approved by the user.

FIG. 10 shows flow chart 901 for configuring out-of-office (OOO) messages based on a message template in accordance with an aspect of the embodiments. At block 1001, a computing device (e.g., computing device 201 as shown in FIG. 2) may display a window from which a user can select the reason for being absent from work. For example, computing device 201 may display a menu containing the flowing selectable items:
Vacation or personal time off
Office closing for holiday
Unavailable after business hours

At block 1002, computing device 201 may provide an appropriate message template. For example, the following are exemplary message templates:

Use this message when a business is closed for a holiday break: Thank you for your email. Our offices are closed from [DAY OF WEEK], [MONTH] [DAY], [YEAR] to [DAY OF WEEK], [MONTH] [DAY], [YEAR], and I will have limited access to email during this time. Your message is very important to me, and I will respond when I return to the office on [DAY OF WEEK], [MONTH] [DAY], [YEAR].

Use this message when one is on vacation or taking personal time off: Thank you for your email. I am out of the office [with limited access to email] and will return on [DAY OF WEEK], [MONTH] [DAY], [YEAR]. Your message is very important to me, and I will respond as soon as possible.
If you need immediate assistance, please contact XXXXX at XXXXX.

A message template may include variable fields in which the user may enter values through an input device of computing device 201. For example, date and contact information may be specified by the user at block 1003. However, as previously discussed, some or all of the information may be embedded in an out-of-office message configurator that is executed by computing device 201.

At block 1004, the OOO message is composed, where the OOS message may be sent in response receiving e-mail when the user is unavailable.

With some embodiments, there may be variations of an OOO message, where the selected variation is based on characteristics of the sender of an e-mail message. For example, different clients may have different escalation contacts. As another example, different degrees of information may be included in intra-business e-mail versus e-mail received from outside the business.

Aspects of the embodiments have been described in terms of illustrative embodiments thereof. Numerous other embodiments, modifications and variations within the scope and spirit of the appended claims will occur to persons of ordinary skill in the art from a review of this disclosure. For example, one of ordinary skill in the art will appreciate that the steps illustrated in the illustrative figures may be performed in other than the recited order, and that one or more steps illustrated may be optional in accordance with aspects of the embodiments.

We claim:

1. An apparatus that is connected to a computer system, the apparatus comprising:
at least one memory device storing instructions; and
at least one computer processor coupled to the at least one memory and that, when executing the instructions stored in the at least one memory, cause the apparatus to perform steps comprising:
determining that an out-of-office (OOO) message configurator is installed on the apparatus;
enabling the out-of-office message configurator to operate in co-operation with the e-mail application for out-of-office messaging;
when the e-mail application is closed and the out-of-office message configurator is enabled, automatically requesting configuration information specifying first content of a first OOO message that is indicative of a first OOO status for a first person; and
when an e-mail message addressed to the first person from a second person is received, returning the first out-of-office message to the second person.

2. The apparatus of claim 1, wherein the at least one processor further causes the apparatus to perform steps comprising is further configured to perform:
when the out-of-office message configurator is not installed and when the e-mail application is opened, downloading the out-of-office message configurator on the apparatus; and
in response to the downloading, enabling the out-of-office message configurator.

3. The apparatus of claim 1, wherein the out-of-office message configurator comprises a macro and wherein the macro includes a series of computer-executable instructions that are grouped together as a single command to accomplish a task automatically.

4. The apparatus of claim 1, wherein the at least one processor further causes the apparatus to perform steps comprising:
verifying, independently of the opening, the enabling, the requesting, and the returning, that the first content of the first out-of-office message is in accordance with known information.

5. The apparatus of claim 1, wherein the at least one processor further causes the apparatus to perform steps comprising:
when the e-mail application is closed and the out-of-office message configurator is enabled, automatically requesting the configuration information specifying second content of a second out-of-office (OOO) message that is indicative of a second out-of-office (OOO) status for the first person;
when the e-mail message addressed to the first person is received and the first person and the first OOO status is valid, returning the first OOO message; and
when the e-mail message addressed to the first person is received and the second OOO status is valid, returning the second OOO message.

6. The apparatus of claim 1, wherein the at least one processor further causes the apparatus to perform steps comprising:
in response to the requesting, comparing a portion of the first content with another source of information.

7. The apparatus of claim 6, wherein the portion of the first content specifies an escalation contact when the first person is unavailable.

8. The apparatus of claim 1, wherein the at least one processor further causes the apparatus to perform steps comprising:
preventing the first person from logging off the computer system until the first content has been specified.

9. The apparatus of claim 1, wherein the at least one processor further causes the apparatus to perform steps comprising:
including escalation contact information in the first content, the escalation contact information specifying an escalation contact for handling the e-mail message when the first person is unavailable.

10. The apparatus of claim 9, wherein the escalation contact information comprises a plurality of escalation levels.

11. The apparatus of claim 9, wherein the at least one processor further causes the apparatus to perform steps comprising:
extracting the escalation contact information from embedded information in the out-of-office message configurator.

12. The apparatus of claim 9, wherein the at least one processor further causes the apparatus to perform steps comprising:
obtaining the escalation contact information from the configuration information entered for the first person.

13. The apparatus of claim 1, wherein the at least one processor further causes the apparatus to perform steps comprising:
pulling an image of the out-of-office message configurator from a source external to the apparatus, wherein the image represents computer-executable instructions of the out-of-office message configurator.

14. The apparatus of claim 1, wherein the at least one processor further causes the apparatus to perform steps comprising:
pushing an image of the out-of-office message configurator from a source external to the apparatus, wherein the image represents computer-executable instructions of the out-of-office message configurator.

15. The apparatus of claim 1, wherein the at least one processor further causes the apparatus to perform steps comprising:
constructing a plurality of versions of the first OOO message; and
selecting one of the plurality of versions based on an identity of the second person.

16. The apparatus of claim 1, wherein the at least one processor further causes the apparatus to perform steps comprising:
analyzing the first content according to a set of rules; and
generating an indication about the analyzing, wherein the indication is indicative that the first content should be modified.

17. The apparatus of claim 16, wherein the set of rules comprises grammatical rules.

18. The apparatus of claim 16, wherein the set of rules comprises spelling rules.

19. The apparatus of claim 16, wherein the set of rules comprises semantic rules.

20. A computer-assisted method comprising:
determining, by a computer device when the computer device is connected to a computer system, that an e-mail application is open, wherein the e-mail application is configured to provide communication services for a first person;
determining that an out-of-office configurator is installed on the computer device;
enabling the out-of-office message configurator, by the computer device, to operate in co-operation with the e-mail application for out-of-office messaging;
when the e-mail application is closed and the out-of-office message configurator is enabled, requesting, by the computer device, configuration information specifying first content of a first out-of-office (OOO) message that is indicative of a first out-of-office (OOO) status for the first person;
when an e-mail message addressed to the first person from a second person is received, returning, by the computer device, the first out-of-office message to the second person; and
when the out-of-office message configurator is not installed and when the e-mail application is opened, downloading the out-of-office message configurator on the computer device.

21. The method of claim 20, further comprising:
when the e-mail application is closed and the out-of-office message configurator is enabled, automatically requesting the configuration information specifying second content of a second out-of-office (OOO) message that is indicative of a second out-of-office (OOO) status for the first person;
when the e-mail message addressed to the first person is received and the first person and the first OOO status is valid, returning the first OOO message; and
when the e-mail message addressed to the first person is received and the second OOO status is valid, returning the second out-of-office message.

22. The method of claim 20, further comprising:
preventing the first person from logging off the computer system until the first content has been specified.

23. A non-transitory computer-readable storage medium storing computer-executable instructions that, when executed by at least one processor, cause an apparatus to perform steps comprising:
opening an e-mail application at a computer device for providing communication services for a first person;
when an out-of-office message configurator is installed on the computer device, enabling the out-of-office message configurator to operate in co-operation with the e-mail application for out-of-office messaging;
when the e-mail application is closed and the out-of-office message configurator is enabled, generating a displayed request on the computer device for configuration information specifying content of an out-of-office (OOO) message that is indicative of an out-of-office (OOO) status for the first person;
modifying the first content when the first content is inconsistent with a set of rules; and
when an e-mail message addressed to the first person from a second person is received, returning the first out-of-office message to the second person.
